(19) United States
(12) Patent Application Publication
(10) Pub. No.: US 2014/0292557 A1
(43) Pub. Date: Oct. 2, 2014

(54) Vehicle Collision Detection And Barrier Deployment System

(71) Applicant: Joseph E. Ajala, Mt. Vernon, NY (US)

(72) Inventor: Joseph E. Ajala, Mt. Vernon, NY (US)

(21) Appl. No.: 13/855,162

(22) Filed: Apr. 2, 2013

(51) Int. Cl. B60R 21/0134; G01S 13/93

(52) U.S. Cl. CPC B60R 21/0134; G01S 13/931
USPC 342/107; 701/45; 342/109

(57) ABSTRACT

The system of the present invention is a vehicle collision warning and prevention system. It is capable of detecting and calculating the speed, distance, location, and arrival time of the oncoming vehicles and determining whether the oncoming vehicles may collide with the vehicle having the system on board. The system thus warns the driver in the vehicle about the speed, distance, location, and the arrival time of the oncoming vehicle (time of accident). The system is capable of deploying barriers (i.e. air cushions or air bags) in a fraction of a second before the collision between the vehicle and the oncoming vehicle. The system is capable of reducing the impact of the auto collision more than any or most auto collision protection in the market today. The system will protect or prevent most body damages to the front and rear of the car in an auto collision.

### BACKGROUND OF THE INVENTION

1. Field of the Invention

The present invention relates to a vehicle collision warning and collision reduction system for warning and reducing the collision with an oncoming vehicle or object thus reducing the damage of the impact, and more particularly relates to a vehicle collision detection and barrier deployment system.

2. Description of Related Art

Currently there are several different types of vehicle collision detection systems. Such systems include forward collision warning sensors using mm-wave radar or laser radar (lidar). Usually they detect the vehicle's range and closing rate to obstacles in the forward path of the vehicle generally within a range of 100-150 m (330-500 ft) and determines whether to alert the driver. Another system utilizes proximity fuse which is a fuse that uses tiny radio. The fuse contains its own tiny radio frequency and sends out a “signal” as it flies through the air “detonating” upon receiving an “echo” back from a “target”. It is a simplified radar. It simply measures the strength of an electromagnetic field and when the strength goes beyond a present limit, it detonates. It works well by itself against a metallic target. Another system uses fluxgate magnetometer which senses movement of the two automobiles in opposite or rear direction which reflect on the sensor/monitor that senses/monitors their velocities in linear and perpendicular directions.

In U.S. Pat. No. 3,952,303, a Doppler radar for forecasting collision, in which three consecutive Doppler signals are obtained by radiating microwave forwardly from the front of a car, the frequency of the microwave being consecutively switched in three steps at a constant interval, and combining the aforesaid microwave and reflected microwave reflected from an object for obtaining intelligence about the distance of the object from the car front, residual time left for the object to reach the car front as well as forecasting collision or non-collision from two of the three Doppler signals and obtaining intelligence about the sense of relative velocity of the object relative to the car front from the remaining Doppler signal and one of the aforesaid two Doppler signals.

In U.S. Pat. No. 7,747,386, a collision detection sensor for detecting a collision of a vehicle and a collision object by converting the collision into a change in optical transmission characteristics of an optical fiber. The collision detection sensor has the optical fiber, a molding material formed on the periphery of the optical fiber, and a convex portion formed on the surface of the molding material.

In U.S. Pat. No. 7,823,683, A collision detection apparatus for a vehicle includes a bumper reinforcement, a chamber forming member, a pressure sensor, collision object determining unit, and a collision position sensor. The bumper reinforcement is mounted on the vehicle and extends in a transverse direction of the vehicle. The chamber forming member is provided at a side of the bumper reinforcement and defines a chamber space that is deformable when the object collides with the vehicle. The pressure sensor detects pressure in the chamber space. The collision object determining unit determines a category of the object by comparing the pressure detected by the pressure sensor with a predetermined determination threshold value. The collision position sensor detects a transverse position, at which the object collides. The determining unit changes the determination threshold value based on the collision position detected by the collision position sensor.

None talks about deployment of a protective barrier if the collision is unavoidable. Therefore, it is necessary to have a system that can detect the threats of an impending collision, warn the driver, and deploy a protective barrier between the vehicle and the oncoming vehicle when the collision is determined unavoidable so as to reduce the damage of the impact.

### SUMMARY OF THE INVENTION

In an exemplary embodiment of the present invention, there is disclosed a vehicle collision detection and barrier deployment system (“VCDBDS” hereinafter). The VCDBDS is a vehicle collision warning and prevention system. It is capable of detecting and calculating the speed and distance of the oncoming vehicles and determining whether the oncoming vehicles may collide with the vehicle having the VCDBDS on board. The system is capable of detecting and identifying oncoming vehicles which may collide with the vehicle based on advanced technologies. The system may comprise Doppler radars to detect and calculate the speed of the oncoming vehicle. It may further comprise a cutting-edge technology that transmits terahertz radiation (“T-rays” hereinafter) to the oncoming vehicle and calculates the speed and distance using the change in frequency between the transmitted T-rays and the reflected T-rays received by photodiodes. The speed, distance and arrival time of the oncoming vehicle can be calculated following the Doppler's effect principle.

If the calculated results meet the pre-determined limits, the system warns the driver in the vehicle about 1) the speed and distance of the oncoming vehicle that might result in an accident collision, and 2) the arrival time of the oncoming vehicle (time of accident); and 3) the distance and location of the oncoming vehicle can also be displayed on a screen.

The system is capable of deploying barriers (i.e. air cushions or air bags) in a fraction of a second before the collision between the vehicle and the oncoming vehicle. The system is capable of reducing the impact of the auto collision more than any or most auto collision protection in the market today. The system will protect or prevent most body damages to the front and rear of the car in an auto collision (especially at 30 to 90 degree angle).

The system comprises a detecting unit for transmitting microwaves and receiving the reflected waves of the transmission waves and/or transmitting T-rays and receiving the reflected T-rays; a control unit for calculating speed, distance, location, and arrival time of the oncoming vehicle, and determining whether or not to deploy the barriers between the vehicle and the oncoming vehicle; and at least one barrier. The detecting unit for transmitting microwaves and/or T-rays and receiving the reflected waves (radiations) comprises a doppler radar, LIDAR (Light Detection And Ranging, also LADAR) which may utilize T-rays and photodiodes. The system may comprise multiple sets of the proximity detector (dopplar radar), LIDAR, photodiodes, and barriers in multiple locations.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows the frontal driver's side of the car with the vehicle collision warning and prevention system.

FIG. 2 shows the rear passive portable solid state electronic THz radiation generator/detector device driver's side of the car with the vehicle collision warning and prevention system.

FIG. 3 shows the rear passenger side airbag deploying.

FIG. 4 shows the front driver's side airbag deploying.

FIG. 5 shows the frontal bumper view with the T-rays transmitter emitter and photodiode hidden behind the passenger and driver's side lights and the license plate.

FIG. 6 shows the rear bumper view with the T-rays transmitter emitter and photodiode hidden behind the passenger and driver's side lights and the license plate.

FIG. 7 shows the front bumper view with the vehicle's lights and license plate opened upon the control center's command and expose the compartment containing the T-rays transmitter emitter and photodiode.

FIG. 8 shows the rear bumper view with the vehicle's lights and license plate opened upon the control center's command and expose the compartment containing the T-rays transmitter emitter and photodiode.

FIG. 9 shows the side view of the frontal device's process of detecting eminent collision through the Doppler radar.

FIG. 10 shows the side view of the rear device's process of detecting eminent collision through the Doppler radar.

FIG. 11 shows type one of the second embodiment of the system where the set of T-rays transmitter and the photodiode are installed on a separate panel at the front and rear of the car below the primary bumper. Only when the control center gives command to expose the T-rays transmitter and the photodiode, the cover would open up.

FIG. 12 shows type two of the second embodiment of the system which comprises three sets of T-rays transmitter and photodiode and the airbags at three locations on the front and/rear side of the car and thus can detect the impact from three different directions from the front and rear and deploy the air bags accordingly.

FIG. 13 shows a trimeter for transmitting waves and receiving reflected waves of the transmission waves.

FIG. 14 shows the proximity detection sensor meter and the indicator with the interference bar.

### DESCRIPTION OF THE PREFERRED EMBODIMENT

Vehicle collision detection and barrier deployment system (“VCDBDS” hereinafter) 500 according to the present invention is a system that warns the driver and prevents the vehicle from directly colliding with an oncoming vehicle (or object) and thus reduces damage of the impact if collision occurred.

The system 500 comprises a detecting unit for transmitting microwaves and receiving the reflected waves of the transmission waves and/or transmitting T-rays and receiving the reflected T-rays; a control center 14 for calculating speed, distance, location, and arrival time of the oncoming vehicle, and determining whether or not to deploy the barriers 13 between the vehicle and the oncoming vehicle; and at least one barrier 13. The detection unit for transmitting microwaves and/or light beams and receiving the reflected waves (radiations) comprises a Doppler radar, LIDAR (Light Detection And Ranging, also LADAR) which may utilize any light beams (including T-rays) and photodiodes 6. The system may comprise multiple sets of the proximity detector (dopplar radar) 4, LIDAR, photodiodes 6, and barriers 13 in multiple locations.

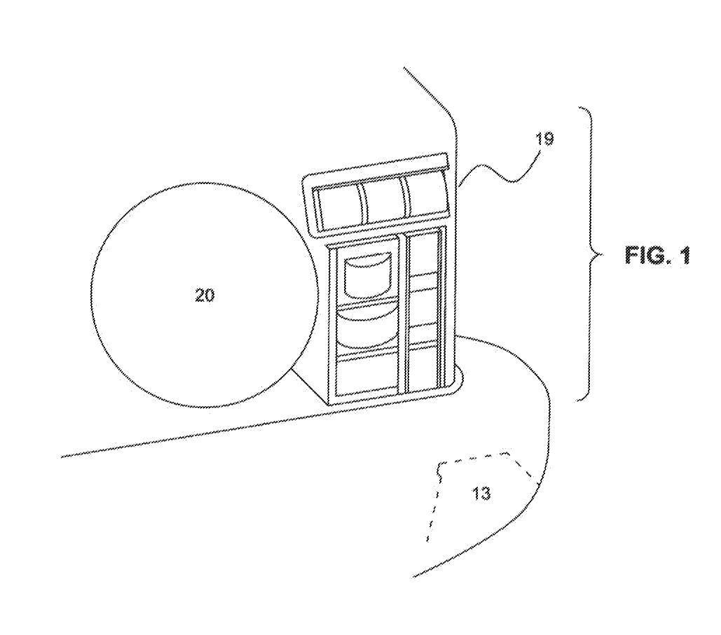

Referring to FIGS. 1-10, there are disclosed a vehicle collision detection and barrier deployment system (“VCDBDS” hereinafter) 500 for warning and preventing the vehicle with the system 500 onboard from directly colliding with an oncoming vehicle (or object) and reducing the impact if collision occurs. The system 500 comprises at least one Doppler radar 10, at least one T-rays transmitter 8, at least one photodiode 6 and at least one barrier 13. The Doppler radar 4 and T-rays transmitter 8, and photodiode 6 are used to detect the oncoming vehicles. The barriers 13 are used to prevent the vehicle from direct impact with the oncoming vehicle (object) and reduce the damage of vehicles due to the impact. The barriers 13 may be any devices that are known in the art. The barriers 13 are installed inside the compartments located within the bumpers at the front and rear sides. The barriers 13 may be air cushions/air bags.

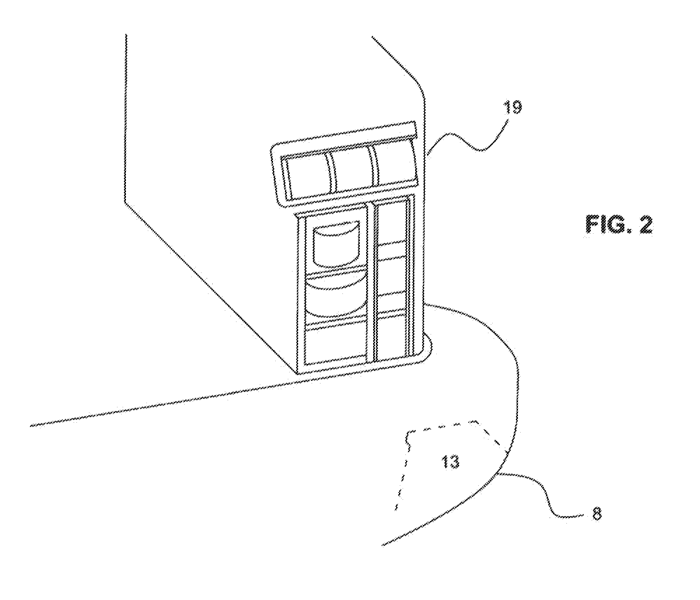

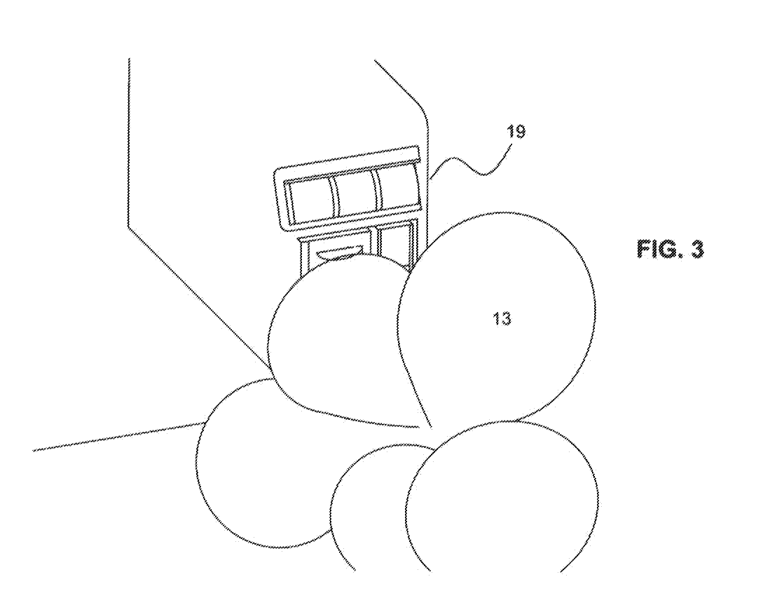

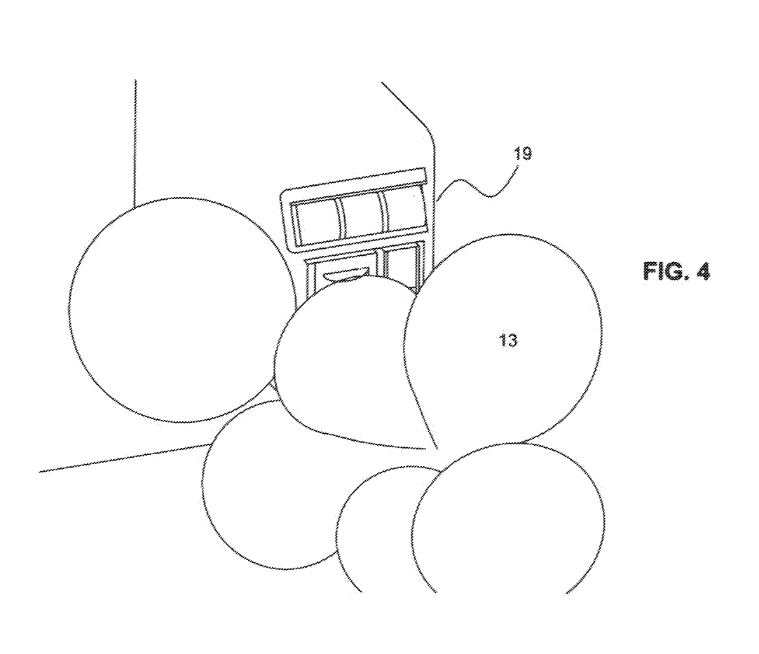

FIG. 1 shows the frontal driver's side of the vehicle with the headlight 20 and side light 19 and FIG. 2 shows the rear side of the car with the side light 19. On the bumper a smart plastic cover 18 covers the compartment containing the 30 degree angle barriers (in stored position) 13. The barriers 13 deploy upon instruction from the control centre 14 to prevent direct impact of the oncoming vehicles to the front and the rear of the vehicle as shown in FIGS. 3-4.

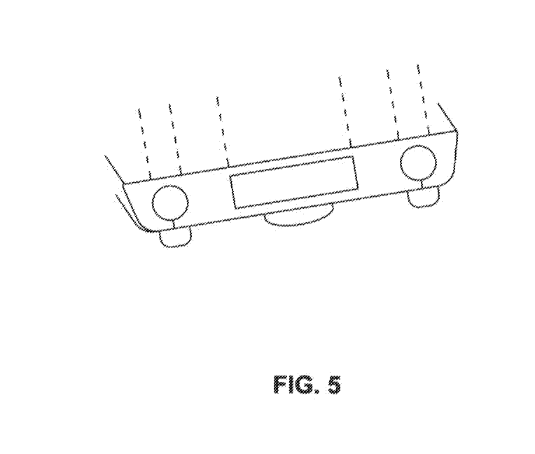

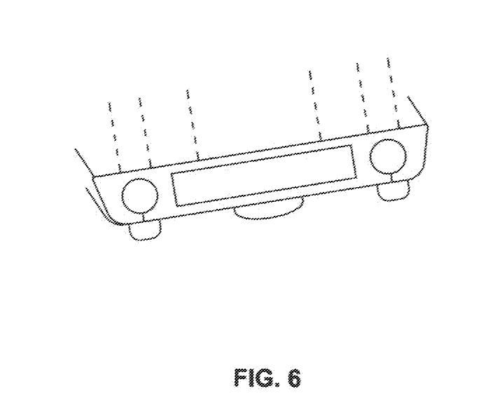

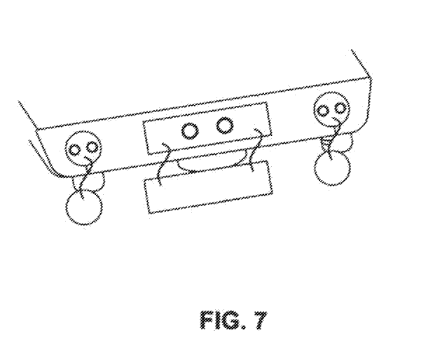

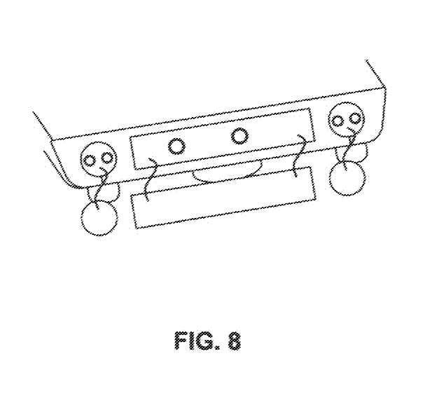

FIGS. 5-6 show the frontal side and rear side of the car with the headlight 20 and side light 19. As shown in FIGS. 5-6, the proximity detector (Doppler radar) 10 is installed underneath the car bumper below the license plate and the driver's side lights 19 and passenger's side light 19. As shown in FIGS. 5-6, the T-rays transmitter 8 and photodiode 6 are hidden behind the passenger and driver's side lights and the license plate. The doppler radar 10 detects the speed and distance of the oncoming vehicles and provide the data to control center 14 to calculate the speed, distance, and/or location. Once the distance is within a predetermined limit which suggests a possible eminent collision, the vehicle's lights and license plate open upon the control center's command and expose the compartment containing the T-rays transmitter 8 and photodiode 6 as shown in FIGS. 7-8. Once the T-rays transmitter 8 and photodiode 6 are unshielded they are able to transmit the T-rays and receive the reflective T-rays. The control center 14 uses the light frequency to calculate the speed, distance and determine whether or not to deploy the barriers 13.

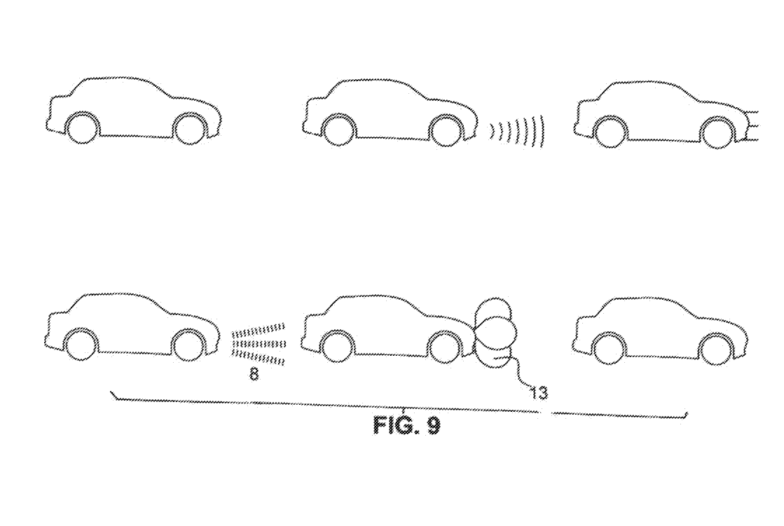

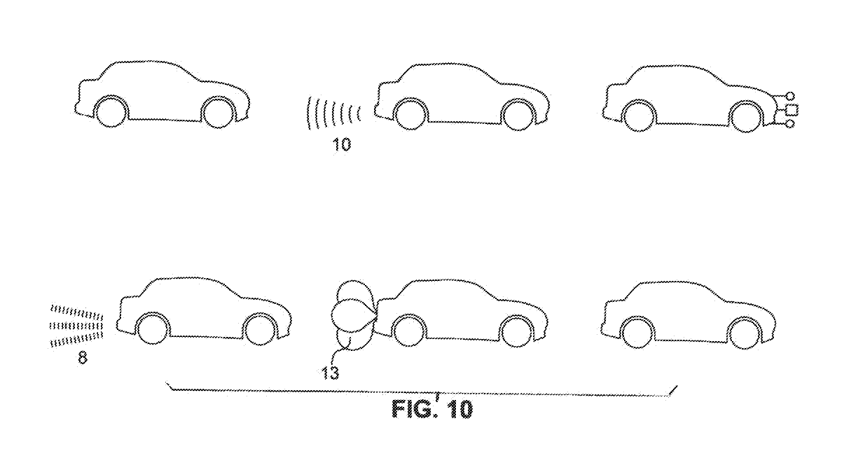

FIGS. 9-10 show the side view of a vehicle going through the process of detecting eminent collision through the proximity detector (Doppler radar) 10, exposing the T-rays transmitter 8, and deploying the frontal barriers 13 or the rear barriers 13.

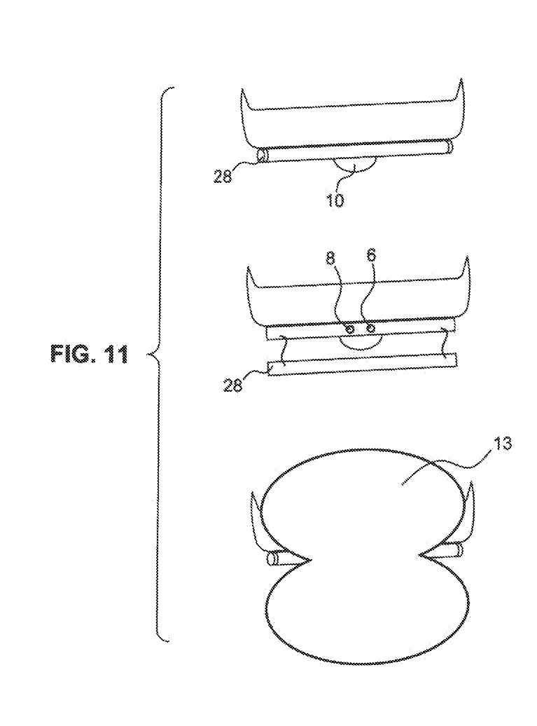

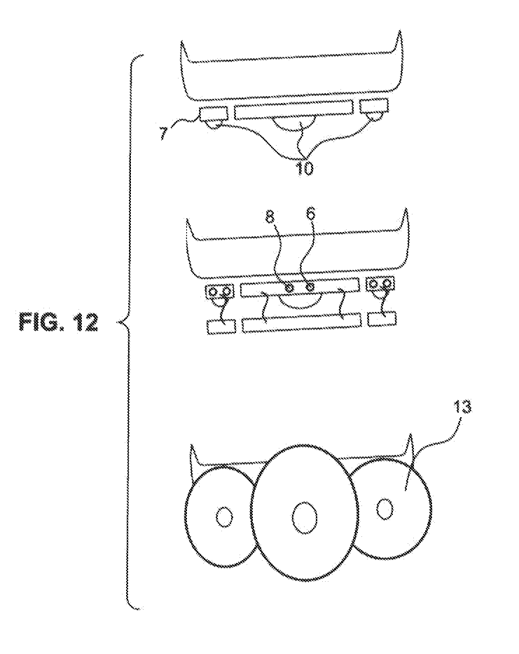

FIGS. 11-12 show a second embodiment of the system 500. In the second embodiment, the set of T-rays transmitter 8 and the photodiode 6 are installed on a separate panel at the front and rear of the car below the primary bumper. This panel has a cover that covers the T-rays transmitter 8 and the photodiode 6. Only when the control center 14 gives command to expose the T-rays transmitter 8 and the photodiode 6, the cover 28 would open up. This second embodiment has two types. The first type comprises only one set of proximity detector (Doppler radar) 10, T-rays transmitter 8, photodiode 6 and air bag 13 at the front end and rear end of the car, respectively as shown in FIG. 11. In the first type only one barrier 13 is installed and will protect the entire frontal side/and rear side of the car as shown in FIG. 11. In the second type as shown in FIG. 12, the system comprises three sets of T-rays transmitter 8 and photodiode 6 and the barriers 13 at three locations on the front and/rear side of the car and thus can detect the impact from three different directions from the front and rear and deploy the barriers 13 accordingly. The proximity detector (Doppler radar) 10 is located on the underside of the car at the front or back end of the car. The system 500 may comprise more sets of The proximity detector (Doppler radar) 10, photodiodes 6, and barriers 13 in more locations than have been described in the foregoing section.

The barriers 13 will be deployed upon receiving the command from the control center 14. The control center 14 also determines whether or not to alert the driver based on a pre-determined limit, generally within a range of 100-150 m (equivalent to 330-500 feet).

The air cushion (or air bags) 13 and the mechanism of air cushion (or air bag) 13 deployment is known in the art. Thus, it is not discussed in the application. The device 500 is time sensitive that engages few milliseconds for each part activation and completing starting from the radar's range to the air cushion ignition and finally air cushion deployment. Each microsecond is very critical. The expanding nitrogen gas inflates the air bag 13 in less than one-twentieth ( 1/20) of a second, splitting open the plastic module cover 18 and inflating in front of the bumper. The bag 13 is fully inflated for only one-tenth ( 1/10) of a second and deflated by three-tenths ( 3/10) of a second.

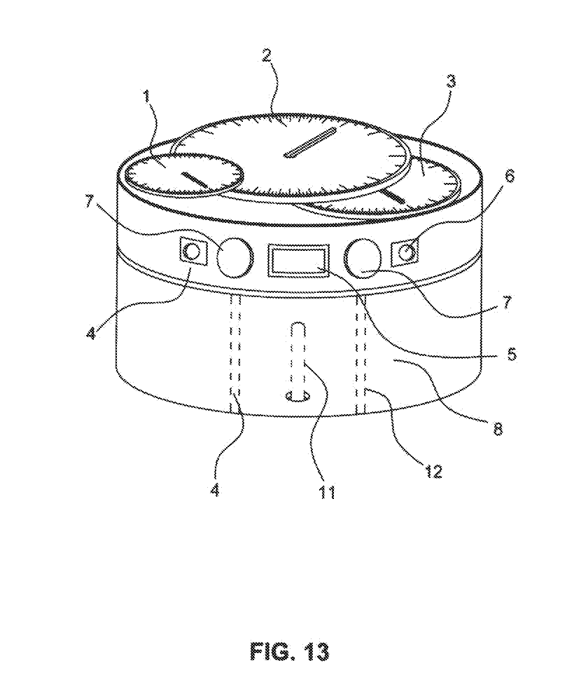

Referring to FIG. 13, there is disclosed a trimeter 50 for transmitting waves and receiving reflected waves of the transmission waves. The trimeter 50 comprises proximity detection sensor meter 1, electric field strength and magnetic field strength measurement meter 2, photodiode measurement meter 3 and their corresponding proximity detection sensor 4, electric field strength and magnetic field strength sensor 5, and a photodiode detection sensor 6. Other components on the trimeter 50 include but are not limited to compass 7, T-ray transmitter 8, plastic optical fiber, and hall effect sensor, etc.

The Doppler effect proximity detection sensor meter 1 is used for detecting the proximity of the oncoming vehicle by using Doppler effect proximity sensor 2 that makes use of the Doppler effect (using a change in frequency between emitted and returning pulses to find the relative speed of the target) to produce velocity data about objects at a distance.

The Doppler transmitter 10 with directional compass 7 emits microwave signal of the Doppler transmitter 10 at specific angles and directions. The Doppler effect proximity detection meter 1 is triggered after three consecutive transmitted signals and returned signals at the same angle detect a target within collision range then the device turns on the T-ray transmitter 8.

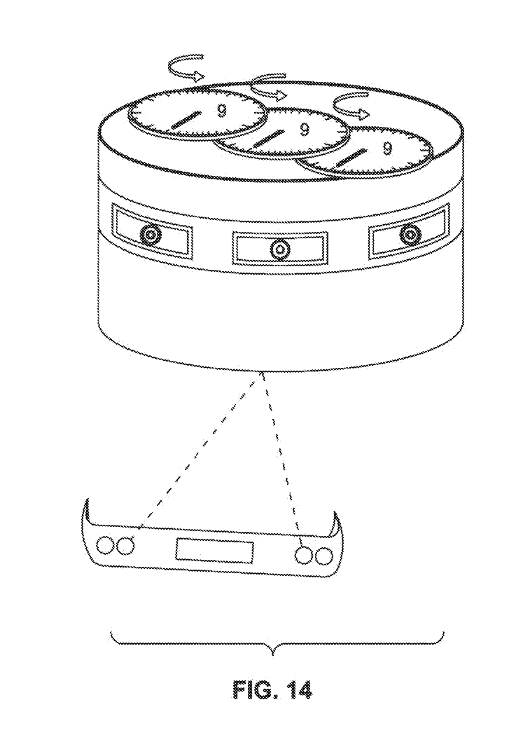

In FIG. 14 it is shown that as the proximity detection sensor meter's 1 reading decreases, the indicator with the interference bar 9 is activated after three consecutive signal increment, then it turns on its T-ray emitter 8.

The Terahertz transmitter 8 comprising: a light source of varying wavelegth 11; electrodes 12 (two pointed strips of metal separated by a 100 nanometer gap on top of a semi-conductor wafer) creating the T-rays. Once shined on an oncoming car, the T-rays are reflected back when it hits the vehicle that is about to cause a collision.

It is only when the light emitter 8 emits light between 30 and 90 degree angle and the photodiode sensor 6 receives the reflected T-rays at angles between 30 and 90 degree angle can a response be triggered by the device to activate or turn on the photodiode measurement meter 3.

A photodiode 6 is used to determine the light intensity where the light intensity is proportional to the photoelectric current. Light or photons are reflected and refracted back to the photodiode 6. Electrons on the photodiode 6 is excited by photon absorption (known as photoexcitation). The excited electrons leave the photodiode 6, generating a current that can be measured by the photodiode measurement meter 3. This whole process is known as the photoelectric effect. A photometer may also be used to determine the light intensity.

The THz control center 14 contains the following components: THz radiation reflection and refraction 15; a solid-state electric THz radiation time-reversed calculator 16, a solid-state electric THz radiation pulse monitor/counter 17 to calculate the distance of the oncoming car and the arrival time. The device 500 can deploy the airbag 13 in time for the collision.

In one embodiment, the VCDBDS of the present invention further comprises a passive activator 21. When the speedometer is activated as the ignition key is turned on-starting the car. When the speedometer gauge is at about 10 mph, the device's passive activator 21 activates the aforementioned components. Using this passive activator 21 can deter the device activation while in a very slow traffic and parked.

The present system may further contain components to deactivate the system 500 by controlling the flow of electricity (current) flowing through the system. The components to deactivate the system 500 may include but are not limited to a Triode-tube/Thermionic tube, Transistor, Semiconductor diodes & transistor, Germanium diodes, Diodes, smart materials (polymetric materials), choke (electricity) or power supply choke, or whatever is known in the art.

The system 500 can also be inactivated through the speedometer sensor when the sender/source speed is below 10 mph or the manufacturer's speed choice. Or when the returned/emitted signals that is not 30 to 90 degree angle to the source vehicle.

The system 500 may further comprise Crash sensors which are designed to prevent the air bag from inflating when the car encounters minor collisions (i.e. bumps). It can also detect the sudden deceleration.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A vehicle collision warning and prevention system for preventing a vehicle from direct collision with an oncoming vehicle comprising:
a detecting unit for transmitting waves and receiving reflected waves of the transmission waves;
at least one barriers between the vehicle and the oncoming vehicle; and
a control unit for calculating speed and distance of the oncoming vehicle, determining whether or not to deploy the barrier between the vehicle and the oncoming vehicle.

2. The vehicle collision warning and prevention system of claim 1, wherein the control unit utilizes Doppler Effect to determine the velocity data about a oncoming vehicle at a distance and determine whether a signal should be send out to trigger deployment of the barrier.

3. The vehicle collision warning and prevention system of claim 2, wherein the detecting unit includes at least one Doppler radar which sends out microwaves towards the oncoming vehicle.

4. The vehicle collision warning and prevention system of claim 3, wherein the detecting unit includes at least one light beam transmitter to transmit light beams and at least one photodiode to receive reflective waves of the transmission wave.

5. The vehicle collision warning and prevention system of claim 4, wherein the transmitter transmits T-rays towards the oncoming vehicle and the photodiode receives reflected waves of the transmitted T-rays.

6. The vehicle collision warning and prevention system of claim 5 wherein the T-rays transmitter comprises a light source of varying wavelength and electrodes consists of two pointed strips of metal separated by an about 100 nanometer gap on top of a semi-conductor wafer, wherein a strong beam of T-rays can be generated by shining light of differing wavelengths on the pair of electrodes.

7. The vehicle collision warning and prevention system of claim 1 further comprising a tri-meter unit for emitting transmission waves and receiving reflected waves of the transmission waves, wherein the tri-meter comprises proximity detection sensor meter, electric field strength and magnetic field strength measurement meter, photodiode measurement meter and their corresponding proximity detection sensor (illuminates when a target is detected), electric field strength and magnetic field strength sensor, and a photodiode detection sensor.

8. The vehicle collision warning and prevention system of claim 7 wherein the control center comprising: T-rays radiation reflection and refraction, a solid-state electric T-rays radiation time-reversed calculator, a solid-state electric T-rays radiation pulse monitor/counter to calculate the distance of the oncoming car and the arrival time.

9. The vehicle collision warning and prevention system of claim 8 wherein the control center warns the driver when the calculated results obtained by the control center based on the waves collected by the tri-meter meets the pre-determined limit.

10. The vehicle collision warning and prevention system of claim 7 wherein the control center send signal to deploy the barriers when the calculated result obtained by the control center based on the waves collected by the trimeter meets the pre-determined limit.

11. The vehicle collision prevention system of claim 1, wherein the at least one barrier is located inside a compartment of the bumper at the front and rear end of the vehicles respectively.

12. The vehicle collision warning and prevention system of claim 3 wherein the at least one Doppler radar is located at underside of the car at the front end and rear end respectively and are covered by a smart plastic cover which is extractable and extendable shield.

13. The vehicle collision warning and prevention system of claim 5 wherein the at least one T-ray transmitter and at least one photodiode are located on a panel located at the front and rear end of the vehicle respectively and the T-ray transmitter and photodiode are covered by a smart plastic cover which is extractable and extendable shield.

14. The vehicle collision warning and prevention system of claim 1 further comprises a passive activator for deterring the system activation while in a very slow traffic and parked and can turn on the system when the speedometer is activated and the gauge is at about 10 mph.

15. The vehicle collision warning and prevention system of claim 1 further comprises components to deactivate the system, the components including but not limited to speedometer sensor and crash sensor.

16. A method for warning and preventing a vehicle from colliding with an oncoming vehicle comprising:
generating T-rays and transmitting T-rays radiation towards an oncoming vehicle;
receiving reflected T-rays radiation;
calculating solid-state electric T-rays radiation reflection time;
monitoring/counting numbers of T-rays radiation pulses;
determining T-rays radiation direction;
determining whether the distance and the angle of the oncoming vehicle meet the pre-determined limits, and
deploying the barriers if the distance and the angle of the oncoming vehicle meet the pre-determined limits.

17. The method for warning and preventing a vehicle from colliding with an oncoming vehicle further comprising:
generating microwaves and transmitting microwaves towards the oncoming vehicle;
receiving the reflected waves of the transmission microwaves;
calculating speed, distance, angle of the oncoming vehicle and determining whether to send signals to warn the driver or to turn on the T-rays transmitter;
sending signals to warn the driver of the vehicle if the calculated speed, distance, angle meet the pre-determined criteria for warning; and
turning on the T-rays transmitter which generates and transmits T-rays if the calculated speed, distance and angle meet the pre-determined criteria for triggering T-rays transmitter.

18. The method for warning and preventing a vehicle from colliding with an oncoming vehicle further comprising:
activating the system when the speedometer gauge is about 10 mph; and deactivating the system when the speedometer gauge is below about 10 mph.

19. The method for warning and preventing a vehicle from colliding with an oncoming vehicle wherein the transmitter generates T-rays by shining light of differing wavelengths onto electrodes which are two pointed strips of metal separated by a 100 nanometer gap on top of a semi-conductor wafer.
